(19) United States
(12) Patent Application Publication
(10) Pub. No.: US 2018/0174241 A1
(43) Pub. Date: Jun. 21, 2018

(54) MICRO-FINANCING PLATFORM FOR POOLED INVESTING BASED ON PURCHASE OF GAME OF CHANCE TICKET OF KNOWN FACE VALUE

(71) Applicant: DIMITRIOS TZOVARAS, THESSALONIKI (GR)

(72) Inventor: DIMITRIOS TZOVARAS, THESSALONIKI (GR)

(21) Appl. No.: 15/846,848

(22) Filed: Dec. 19, 2017

Related U.S. Application Data
(60) Provisional application No. 62/436,979, filed on Dec. 20, 2016.

(51) Int. Cl. G06Q 40/06; G07F 17/32

(52) U.S. Cl. CPC G06Q 40/06; G07F 17/329

(57) ABSTRACT

An improved micro-financing platform to fund principally new ideas, startups, and/or SMEs using a new type of instant game of chance ticket is described. In accordance with an exemplary embodiment, the instant game of chance ticket will comprise a gaming component and an investment component. In one scenario, the gaming component is the traditional game feature offered by an instant game of chance ticket. The investment component of a ticket is the investment value of a ticket as a function of the face value paid for the ticket. This investment value is a sort of micro-financing investment made by the purchaser in return for which he is given a share interest in a pool of companies very similar to traditional share ownership in a company; or the purchase of a corporate bond exercisable at a future date in exchange for, hopefully, greater value than what was given to acquire in the first place.

### RELATED APPLICATIONS

This application claims the benefit of U.S. Provisional Application No. 62/436,979 filed on Dec. 20, 2016, entitled “MICRO-FINANCING PLATFORM FOR POOLED INVESTING BASED ON PURCHASE OF GAME OF CHANCE TICKET OF KNOWN FACE VALUE”, commonly owned and assigned to the same assignee hereof.

### FIELD

The present disclosure relates to micro-financing type platforms, and in particular to platforms for managing micro-investments using instant game of chance tickets.

### BACKGROUND

The success and legalization of crowd funding for micro-financing type investments has made it possible for amateur investors and young entrepreneurs with limited funding to be able to join forces for the first time. The present invention expands on this notion by creating a new type of micro-financing vehicle that provides a fun, simple, and exciting way for amateur investors to invest in business ventures just starting out and looking for initial operating capital.

### SUMMARY

The present disclosure is directed to a new micro-financing platform to fund principally new ideas, startups, and/or SMEs using a new type of instant game of chance ticket. An instant game of chance ticket is a scratch card bought from a normal retail establishment, a lotto ticket purchased from a retail gaming operator, an in-play sports betting ticket, or the like. The place of purchase could be a commercial (gaming or non-gaming establishment) or could be a non-commercial venue (church, university, non-profit organization). Similarly, the motivation of the buyer of an instant game of chance ticket may also be philanthropic or profit-motivated.

In accordance with an exemplary embodiment, the instant game of chance ticket will comprise a gaming component and an investment component. In one scenario, the gaming component is the traditional game feature offered by an instant game of chance ticket. The investment component of a ticket is the investment value of a ticket as a function of the face value paid for the ticket. This investment value is a sort of micro-financing investment made by the purchaser in return for which he is given a share interest in a pool of companies very similar to traditional share ownership in a company; or the purchase of a corporate bond exercisable at a future date in exchange for, hopefully, greater value than what was given to acquire in the first place.

These and other features and advantages of the present invention will be apparent from the description of exemplary embodiments provided herein.

### BRIEF DESCRIPTION OF THE DRAWINGS

FIG. 1 shows a system diagram of a micro-financing platform and its interconnections to other systems and devices.

FIG. 2 shows a flow diagram of the main steps of managing the instant game of chance investments.

FIG. 3 shows the different stakeholders roles and actions for the micro-financing platform.

FIG. 4 shows how major liquidity events affect dividends.

FIG. 5 shows an example of how gaming component winnings are handled.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

The following description is intended to convey a thorough understanding of the embodiments described by providing a number of specific embodiments and details involving methods and systems for managing content submission and publication of content. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

The terminology used herein is for the purpose of describing particular embodiments only and is not intended to limit the scope of the present invention. As used throughout this disclosure, the singular forms “a,” “an,” and “the” include plural reference unless the context clearly dictates otherwise. Thus, for example, a reference to “a module” includes a plurality of such modules, as well as a single module, and equivalents thereof known to those skilled in the art.

The present disclosure is directed to a new micro-financing platform to fund principally new ideas, startups, and/or SMEs using a new type of instant game of chance ticket. An instant game of chance ticket is a scratch card bought from a normal retail establishment, a lotto ticket purchased from a retail gaming operator, an in-play sports betting ticket, or the like. The place of purchase could be a commercial (gaming or non-gaming establishment) or could be a non-commercial venue (church, university, non-profit organization). Similarly, the motivation of the buyer of an instant game of chance ticket may also be philanthropic or profit-motivated.

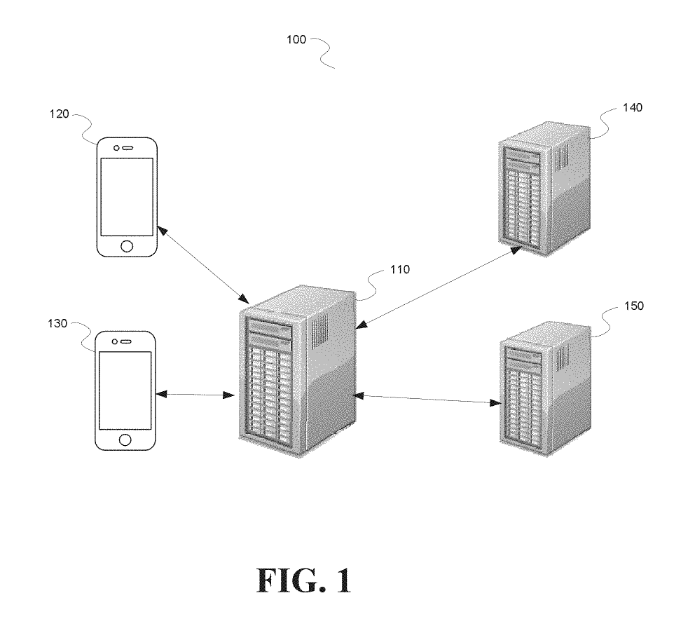

FIG. 1 shows a system diagram of a micro-financing platform and its interconnections to other systems and devices. Components 100 of the system diagram include micro-financing platform 110, user computing devices 120, 130, game operator system 140, and other computing systems 150 (e.g. tax, regulator, etc. systems). Platform 110, and systems 140, 150 are implemented in any known hardware computing technology running software written in any known computer language. User devices 120, 130 include mobile devices such as smart phones, tablets, laptops, desktop computers and the like. All interconnected components 100 are configured to exchange data, and control information used for managing gaming and investments according to the following exemplary embodiments.

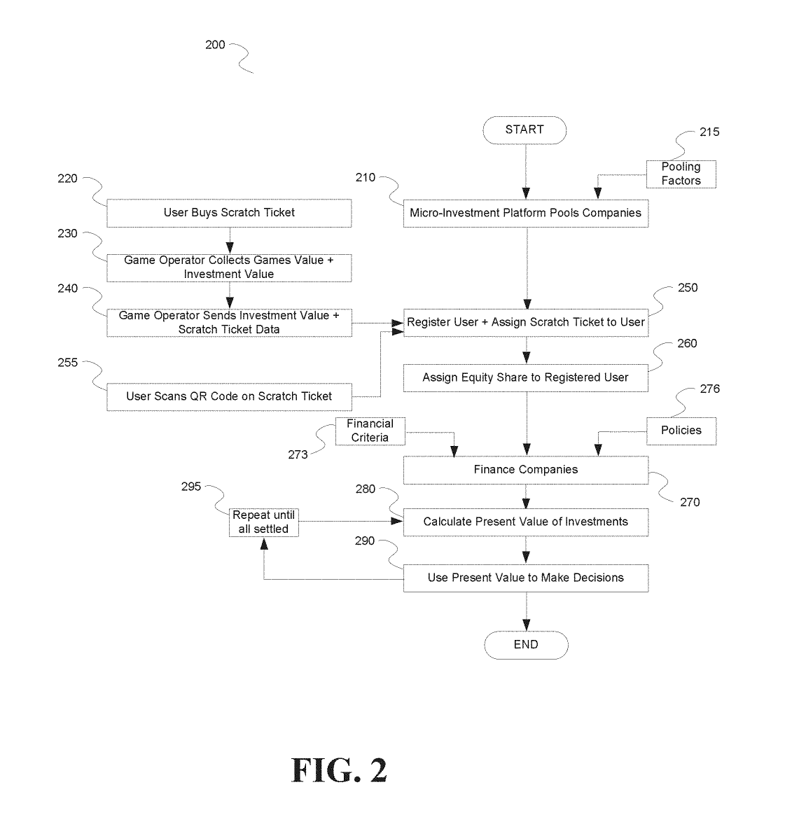

In accordance with an exemplary embodiment, the instant game of chance ticket will comprise a gaming component and an investment component. FIG. 2 shows a flow diagram of the main steps of managing the instant game of chance investments. In one scenario, the gaming component is the traditional game feature offered by an instant game of chance ticket. The investment component of a ticket is the investment value of a ticket as a function of the face value paid for the ticket. This investment value is a sort of micro-financing investment made by the purchaser in return for which he is given a share interest in a pool of companies very similar to traditional share ownership in a company; or the purchase of a corporate bond exercisable at a future date in exchange for, hopefully, greater value than what was given to acquire in the first place.

In an example scenario, a user purchases an instant scratch card (step 220). The value of the equity interest bearing $5.00 instant scratch card is collected by the game operator (step 230) and the value is allocated as follows: $3.00 which goes toward the purchase of the scratch card and is the gaming fee charged by the gaming operator responsible for promoting, selling and managing winnings associated with the scratch card (“the gaming component”); and $2.00 which is the separate and distinct investment value of the ticket.

In one aspect, the $2.00 is collected by the gaming operator and forwarded to the micro-financing platform together with instant scratch ticket data (e.g. a code) to the platform 110 (in step 240). Unlike traditional crowd funding where an investor selects the company he wishes to invest in, in the present case, the platform offerings are to a pool of companies that are preselected in step 210. The pre-selection process can vary from platform to platform, or a platform could offer many different investment options. Examples of different investment options include the pooling of companies based on size, location, age of founders, age of company, technology focus, industry focus, revenues, green-friendliness, pay out risks, target number of investors, and many other similar factors, or combination of factors 215.

Accordingly, users are availed of purchase selections which they can tailor to their own causes and/or interests. For example, a car enthusiast may select scratch cards with investment focus having to do with startups or SMEs in the auto industry; while an ecologist may select a green-friendly investment mix.

The pooling of the companies is predefined and established by the platform operator. The selection of the companies that go into a pool is similarly determined by a number of different factors. The selection could be random, first come first served, selected on the basis of a competition between initial applicants, and/or based on a voting scheme where selections are based on most votes received by platform members.

Accordingly, the investment component is an investment in a pool of companies very similar in nature to money market funds, except in a micro-financing type vehicle.

In one scenario, the game of chance is a ticket with a hidden identifier. A user purchases and scratches his ticket to reveal a hidden identifier code, e.g. a QR code, which code uniquely identifies his ticket. He then sends the code to the platform (e.g. manually entering the code). In an exemplary embodiment where a QR code is used, the user scans the QR code with his devices in step 255 and sends it to platform 110. Platform 110, uses the received QR code and the data received from the game operator in step 240 and registers the user (i.e. the owner of the ticket).

In a variation of the present exemplary embodiment, the user may have previously registered with the platform, before he sends the hidden code to the platform, e.g. when he bought another ticket at an earlier date or time.

In step 250, the ticket will be matched to a registered platform member, at which time the ticket can be discarded. Once the ticket is registered with the platform, the ticket is no longer tradable by bearer. The registered owner will have to go on the platform and reassign it to another user. This is to protect against theft or possible tempering.

Platform 110 then continues in step 260 assigning an equity share to the user and finances companies in the pool (step 270) according to financial criteria 273 and policies 276.

The idea is to make scratch card players also stakeholders in startups to help support a region's local innovation needs. In essence, we are talking about a new and different form of micro-financing. Of course, for there to be any payback on the $2.00 investment, the pool needs to be able to buy back the equity interest that it gave the scratch card holder in exchange for the $2.00. To do this, a mechanism is needed that forecasts the real market value of the $2.00 at the time the stakeholder wishes to convert his investment into cash or points (i.e. the investment's present value at that instant in time). This forecasting is done by the platform in step 280 and the present value of the investment is used in step 290 to make investment and pooling decisions. Steps 280, 290 may be repeated at any time until all investment and pooling issues are resolved (step 295) e.g. when a pool is ended.

The initial $2.00 equity interest may be traded on the platform by, for example, (a) having the platform facilitate buy/sell transactions between members (other scratch card stakeholders) similar to trading of interests in assets on crowd funding platforms; (b) the equity interest could be bought by the platform at an agreed (discounted) value to be resold, (c) it could be sold on the platform to the brokerage company that manages the pool; and/or (d) it could be traded for points to buy an equity interest in a different pool without necessarily having to physically go to a retailer and buy another scratch card for that different pool, and of course without having to invest $3.00 again on the gaming component associated with this “another” scratch card.

As should be clear, the use of a centralized platform to trade micro-financing investments as proposed can serve as a clever vehicle for a state to help promote innovation. The state (and/or corporations for that matter) can participate by matching investments, or offering favorable tax treatment for winnings, especially winnings that are reinvested for long periods into new pools.

The risk of failure of one company in the pool should be offset by the hopefully greater number of successful companies overall to make the risk-reward proposition particularly attractive.

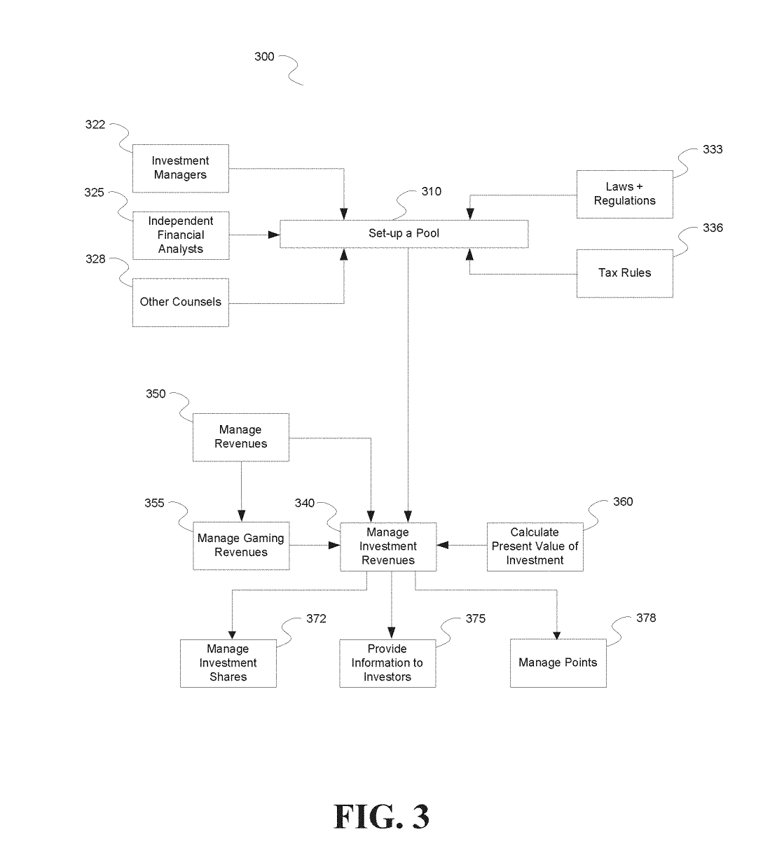

FIG. 3 shows the different stakeholders roles and actions for the micro-financing platform. The stakeholder roles and actions 300 are given in a diagrammatic form to illustrate interactions. In one example implementation involving a pool (set-up in step 310) consisting of ten fin-tech start-ups, a manager will manage the proceeds from ticket sales (step 350). The pool of step 310 is formed by using input from a plurality of stakeholders, including investment managers 322, independent financial analysts 325 and other counsels 328, and using laws, regulations, and tax rules data from systems 140, 150.

The proceeds to be managed include gaming revenues (step 355) and investment revenues (step 340). The investment revenues will flow to the start-ups from the collection and management of investment component monies collected from the sale of tickets, according to a criterion, e.g. in equal amounts AND only when a critical mass of tickets is collected. In another scenario, money may flow based on needs of each company, rank order based on number of highest votes (for example, first place gets a 20% premium above rest of companies in pool), or divided based on optimum investment value as determined by an independent financial advisor or investment manager entrusted with management responsibility over the pool.

Investment Revenue Management in step 340 also uses as input the available pools from step 310 and the present value of the investment from step 360. Step 340 uses all these input data to manage investment shares (step 372) assigned to each ticket associated with a registered user, provide information to investors (step 375), and manage investment points (step 378) in exemplary embodiments, where the investment shares in companies of a pool are replaced with investment points for easier exchange of user ownership between investments and according to their present value at a specific time.

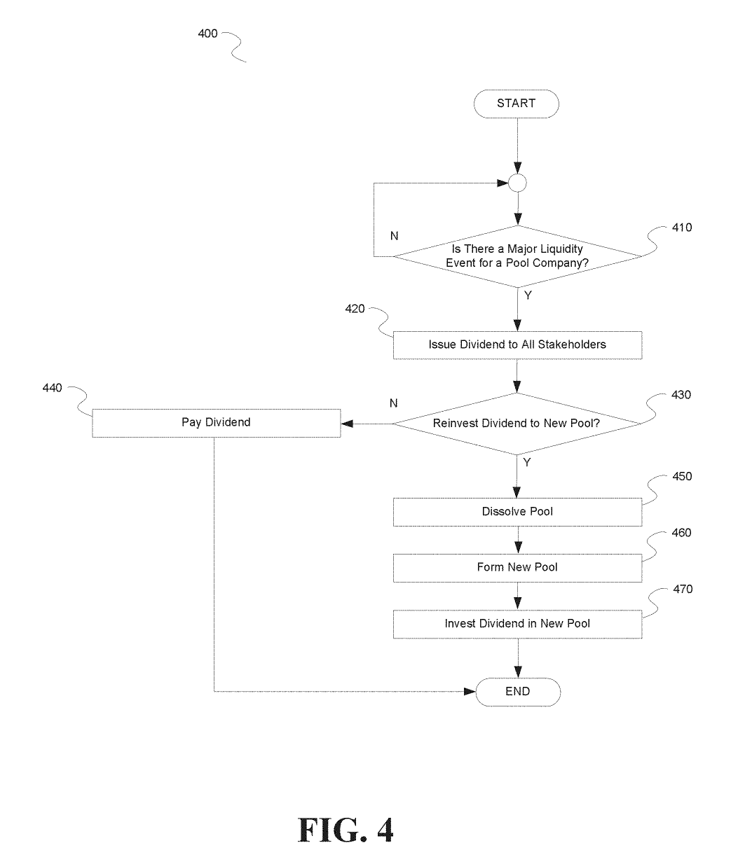

FIG. 4 shown how major liquidity events affect dividends. Platform policies and/or specific policies associated with each pool specify when the pool can be liquidated, and/or when, if and how companies can enter or leave the pool, if at all. For example, when a major liquidity event happens for a company in the pool (Step 410), dividends are issued (step 420) and paid to all stakeholders (step 440). If a decision is made to reinvest the dividend in a new pool (step 420), the platform dissolves the existing pool (step 450) and forms a new pool (step 460) and gives the stakeholders of the former pool the option to acquire an interest in the new pool (step 470) without giving back any money to stakeholders, this way the increase in capital flows to a new round of startups.

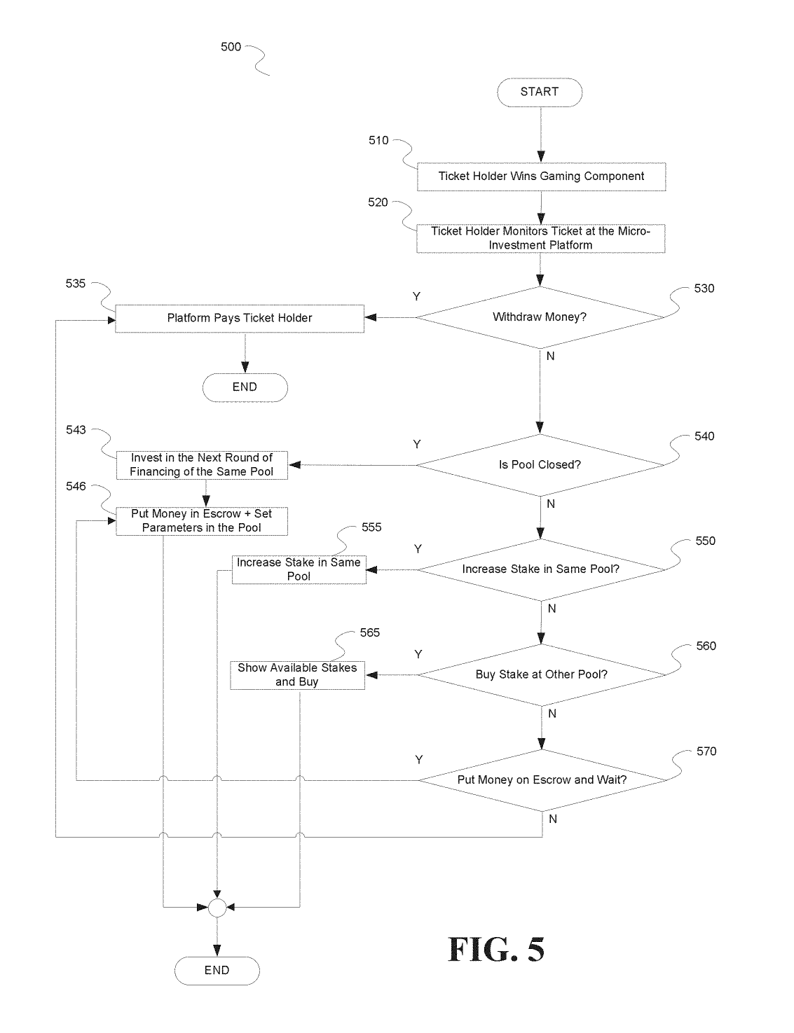

FIG. 5 shows an example of how gaming component winnings are handled. The platform role is absolutely critical. In one scenario, gaming component winnings (step 510) optionally or automatically also convert over to a corresponding investment value. This way, in addition to having acquired a $2.00 investment value in a pool of companies whose progress the user can see and monitor on the platform as a registered member (step 520), the user can also increase his stake in the pool by not withdrawing his money (step 530) or by having his winnings applied to invest in the next round of financing of the pool (step 543) if the pool is closed. Since the next round of financing may not be before some time, the winnings are put in escrow until the investment is possible (step 546); in the same step appropriate parameters are set in the platform to allow the platform to keep track of future investment opportunities for the money in escrow. If the pool is still open, the user can acquire an even greater stake in the current pool (steps 550-555). The user of the platform is also offered an opportunity to apply his winnings to another pool (step 560), taking advantage of information of available stakes in this other pool shown to him by the platform and buying his selected stakes (step 565). The user can also set aside the money so it is held on escrow (570, 546) by the platform earning interest until he is ready to invest or withdraw it. If no selection is made or if the user chooses to withdraw his winnings in step 530, the platform pays the ticket holder, i.e. the registered user (step 535).

The platform operator provides a number of different functional roles. One such role is to set-up the pools making sure compliance with local laws and rules, manage tax issues, work closely with investment managers and financial advisors to make sure that pool offerings and prospectuses are available and appropriate. A second role is to operate the gaming component aspect of the ticket purchase to make sure that the winnings from those operations do not interfere with the investment component activities. In one scenario, the gaming activities are managed by a separate entity. The separate entity is any gaming operator, including an online gaming operator. The ticket offered by the gaming operator can be unique with different tickets corresponding to different pools available and supported by the platform. QR codes on each ticket may be used to provide on the spot, real time available information about a pool, including information about how close a pool is to meeting its investment goal. This way, before wagering on a scratch ticket, the user may wish to consider whether the pool is also a good investment on the basis of investor interest in the tickets sold for that pool to date.

In a related scenario, the investment value of the investment component of a ticket corresponds to a certain number of points. These points may vary as a function of pool maturity, success, changing risk-reward factors, a company having landed a huge client for example, or conversely, lost a big client, the announcement of an initial public offering (IPO) of a company, greater interest in that pool by the community (registered members) at large as opposed to other pools, interest by members to trade points into/or out of a pool, and many other factors. Based on these factors, in the $2.00 investment value example, on January 1 of year X, this $2.00 may translate into 200 points, whereas had the same $5.00 ticket been purchased six months earlier it may have translated to only 100 points (assuming pool is doing well), and 600 points, if in January it is faring poorly. In each instance, the intent is to reflect the present value of the $2.00 price attributed to the investment component. Historical information about the pool serves adds another level of strategy to ticket play, and thus extends the entertainment value associated with investing.

In yet a further scenario, the gaming and investment components being integral, the platform may provide information about the sales and chances of winning the gaming portion of the ticket. For example, assume that for a given pool, the target fund raising goal is $1M, and let's assume that all of the $500k winnings automatically convert to points. Let's also assume that all the gaming component value of the tickets sold goes to the gaming operator to support his activities plus a small profit. In this example, the total investment value of the tickets to be sold needs to be $500K, with the other $500k coming from the scratch winnings that will roll into the investment component. If tickets have been sold to the tune of $450k, meaning all but $50k remain to be sold, however, if out of those unsold tickets, there are more than $300k (of the $500k) in yet unpaid winnings, the odds of winning on one of the tickets remaining to be sold is much higher than average, which should make a pool more attractive over another pool where the opposite is true: i.e., the other pool has $450k in already distributed winnings and $200k in unsold tickets. This scheme could have the desirable benefit, from a social engineering standpoint, of encouraging millions of micro investors to support less popular and/or higher risk companies and ideas.

The above scheme also provides a measure of protection for the gaming operator who might have its scratch cards stolen, burned in a fire, or is simply unable to sell them, since the platform would provide a safety net against those eventualities, and also arrange for their reprinting by the gaming operator. In another scenario, the investment component not sold by traditional retail methods, may be offered online by the platform. In fact, the platform may make possible the parallel raising of capital for micro-financed pools on the platform.

It should be appreciated that while the above examples and scenarios have been described in connection with micro-financing investments (as the term is normally used and understood by the financial community), the same principles can be applied to traditional investing. The pools can comprise traditional, large market money funds of public companies or other type pools of equities, pooled option market offerings, pooled currency market offerings, pooled derivatives, different crypto-currencies, commodities and derivatives, among other things. Additionally, a pool can very simply be comprised of a single company in certain circumstances.

The platform may be configured as an independent operator charging commissions and profiting only from the trading of points between members and/or with the platform.

In addition, the platform may establish a network of mentors and relations with professional service providers, such as corporate counsel, patent attorneys, business developer experts, and others. All or a portion of the total collected investment capital from micro investors—from the sale of tickets—may instead be used to provide many pooled entities with free or discounted services. In exchange for agreeing to pull their money this way, each micro-investor may receive an appropriate equity investment in these companies.

Various embodiments of the invention are described above in the Detailed Description. While these descriptions directly describe the above embodiments, it is understood that those skilled in the art may conceive modifications and/or variations to the specific embodiments shown and described herein.

Any modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s).

The foregoing description of a preferred embodiment and best mode of the invention known to the applicant at this time of filing the application has been presented and is intended for the purposes of illustration and description. It is not intended to be exhaustive or limit the invention to the precise form disclosed and many modifications and variations are possible in the light of the above teachings.

The embodiment was chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out this invention, but that the invention will include all embodiments falling within the scope of the appended claims.

In one or more exemplary embodiments, the functions described may be implemented in hardware, software, firmware, or any combination thereof. If implemented in software, the functions may be stored on or transmitted over as one or more instructions or code on a computer readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blue-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computer implemented method for tracking investments in pools, comprising:
identifying the investment value in a game of chance ticket purchased by a registered member; and
converting the investment value to a corresponding micro-investor interest in the pool,
where the game of chance ticket includes a gaming component of fixed value, and where the investment value and the fixed value correspond to a purchase value of the game of chance ticket.

2. The method of claim 1, further comprising:
calculating the present value of the investment and of alternative investments; and
exchanging the micro-investor interest in the pool for a different interest in the same pool or for an interest in another pool.

3. The method of claim 1, further comprising reinvesting the winnings corresponding to the fixed value of the gaming component into the same pool or into another pool, or into a combination of both pools.

4. The method of claim 2, where the exchange of the micro-investor interest is done using legal, regulatory, and tax restrictions.

5. The method of claim 4, where the exchange of the micro-investor interest also uses financial analysis data.

6. The method of claim 2, where exchanging the micro-investor interest in the pool for a different interest in the same pool or for an interest in another pool is done by first converting the micro-investor interest in the pool into investment points.

7. A computing platform for tracking investments in pools, the computing platform comprising:
means for identifying the investment value in a game of chance ticket purchased by a registered member; and
means for converting the investment value to a corresponding micro-investor interest in the pool,
where the game of chance ticket includes a gaming component of fixed value, and where the investment value and the fixed value correspond to a purchase value of the game of chance ticket.

8. The computing platform of claim 7, the computing platform further comprising:
means for calculating the present value of the investment and of alternative investments; and
means for exchanging the micro-investor interest in the pool for a different interest in the same pool or for an interest in another pool.

9. The computing platform of claim 7, the computing platform further comprising means for reinvesting the winnings corresponding to the fixed value of the gaming component into the same pool or into another pool, or into a combination of both pools.

10. The computing platform of claim 8, where the means for exchanging the micro-investor interest in the pool for a different interest in the same pool or for an interest in another pool is done by first using means for converting the micro-investor interest in the pool into investment points.

11. A non-transitory computer program product that causes a computing platform to track investments in pools, the non-transitory computer program product having instructions to:
identify the investment value in a game of chance ticket purchased by a registered member; and
convert the investment value to a corresponding micro-investor interest in the pool,
where the game of chance ticket includes a gaming component of fixed value, and where the investment value and the fixed value correspond to a purchase value of the game of chance ticket.

12. The non-transitory computer program product of claim 11 having further instructions to:
calculate the present value of the investment and of alternative investments; and
exchange the micro-investor interest in the pool for a different interest in the same pool or for an interest in another pool.

13. The non-transitory computer program product of claim 11 having further instructions to reinvesting the winnings corresponding to the fixed value of the gaming component into the same pool or into another pool, or into a combination of both pools.

14. The non-transitory computer program product of claim 11, where exchanging the micro-investor interest in the pool for a different interest in the same pool or for an interest in another pool is done by first converting the micro-investor interest in the pool into investment points.
